(19) United States
(12) Patent Application Publication
(10) Pub. No.: US 2026/0359226 A1
(43) Pub. Date: Nov. 12, 2026

(54) CACHE WAY IDENTITY (ID) LIMITER

(71) Applicant: QUALCOMM Incorporated, San Diego, CA (US)

(72) Inventors: Ron BERCOVICH, Woluwe-Saint-Pierre (BE); Albert YOSHER, Tel Mond (IL); Ran HAY, Rosh Haaein (IL); Alon RACHMANI, Rehovot (IL); Doron KARNIBAD, Tel Mond (IL); Alon GLICK, Tel Aviv (IL)

(21) Appl. No.: 19/201,729

(22) Filed: May 7, 2025

(51) Int. Cl. G06F 12/0864

(52) U.S. Cl. CPC G06F 12/0864

(57) ABSTRACT

A method of data caching includes assigning a first cache way limit to a first address range of memory. The first cache way limit assigns a first associativity level for the first address range. The method also includes caching first data from the first address range into a first specific subset of cache ways of a multi-way set associative cache memory, in accordance with the first cache way limit.

### BACKGROUND

### Field

Aspects of the present disclosure relate to computing devices, and more specifically to cache memory.

### Background

Mobile or portable computing devices include mobile phones, laptop, palmtop and tablet computers, portable digital assistants (PDAs), portable game consoles, and other portable electronic devices. Mobile computing devices are comprised of many electrical components that consume power and generate heat. The components (or compute devices) may include system-on-a-chip (SoC) devices, graphics processing unit (GPU) devices, neural processing unit (NPU) devices, digital signal processors (DSPs), and modems, among others. Each of these devices may include cache memory accessed by multiple threads executing in parallel. It would be desirable to improve cache memory access for threads executing in parallel.

### SUMMARY

In aspects of the present disclosure, a method of data caching includes assigning a first cache way limit to a first address range of memory. The first cache way limit assigns a first associativity level for the first address range. The method also includes caching first data from the first address range into a first specific subset of cache ways of a multi-way set associative cache memory, in accordance with the first cache way limit.

Other aspects of the present disclosure are directed to an apparatus. The apparatus has one or more memories and one or more processors coupled to the one or more memories. The processor(s) is configured to assign a first cache way limit to a first address range of memory. The first cache way limit assigns a first associativity level for the first address range. The processor(s) is also configured to cache first data from the first address range into a first specific subset of cache ways of a multi-way set associative cache memory, in accordance with the first cache way limit.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-a-chip (SoC), including a set associative cache memory system with limited way allocation, in accordance with certain aspects of the present disclosure.

FIG. 2 is a block diagram illustrating limits on ways in a four-way associative cache, in accordance with various aspects of the present disclosure.

FIG. 3 is a block diagram illustrating a microarchitecture for implementing limited way assignments, in accordance with various aspects of the present disclosure.

FIG. 4 is a flow diagram illustrating an example process performed, for example, by a mobile device, in accordance with various aspects of the present disclosure.

FIG. 5 is a block diagram showing an exemplary wireless communications system in which a configuration of the present disclosure may be advantageously employed.

FIG. 6 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced.

The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

One type of cache architecture is a set associative cache architecture that allows for specific data or instructions to be allocated to a variety of cache lines. A set associative cache is organized into a two-dimensional array of blocks (also referred to as cache lines). The columns of a block are referred to as cache ways or cache sets. Each way may store multiple cache lines. Multiple ways may be included in a cache set. A set associative cache architecture may be implemented for multi-context applications executing simultaneously while using the cache. With a set associative cache in a multi-threaded system, a low priority software thread executing in parallel with multiple high or mid priority threads utilizing the same cache can cause thrashing and performance degradations.

Aspects of the present disclosure are related to constraining or limiting way allocation for set associative cache systems. More specifically, aspects of the present disclosure enable selective way identifiers (IDs) limiting which ways are not available for use by specific applications/tasks/data. A programmable mechanism may be provided to assign different ways to different applications/tasks/data. That is, applications/tasks/data may be limited to specific ways.

Particular aspects of the subject matter described in this disclosure can be implemented to realize one or more of the following potential advantages. In some examples, the described techniques, such as limited way allocation, reduce the impact on the performance and thrashing of other code or data execution using a shared cache.

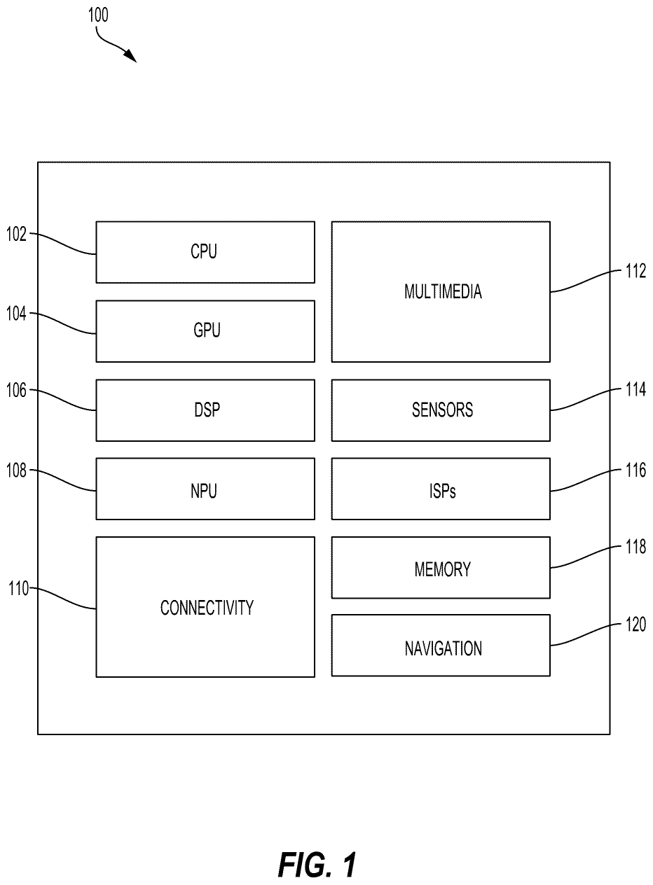

FIG. 1 illustrates an example implementation of a host system-on-a-chip (SoC) 100, which includes a set associative cache memory system with limited way allocation, in accordance with aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, Wi-Fi connectivity, universal serial bus (USB) connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

According to aspects of the present disclosure, a mobile device includes a set associative cache memory system with limited way allocation. The cache memory system may include means for assigning and means for caching. In one configuration, the assigning means and the caching means may be the CPU 102, GPU 104, DSP 106, NPU 108, memory 118, tag memory, Bank/WayN, multiplexor 202, lightweight memory management unit (LMMU), and/or class configuration registers, as shown in FIGS. 1-3. In other aspects, the aforementioned means may be any structure or any material configured to perform the functions recited by the aforementioned means.

One type of cache architecture is a set associative cache architecture that allows for specific data or instructions to be allocated to a variety of cache lines. A set associative cache is organized into a two-dimensional array of blocks. The columns of a block are referred to as ways. Each way may store multiple cache lines. Multiple ways may be included in a cache set. A set associative cache architecture may be implemented for multi-context applications executing simultaneously while using the cache. With a set associative cache in a multi-threaded system, a low priority software thread executing in parallel with multiple high or mid priority threads utilizing the same cache can cause thrashing and performance degradations.

One solution is to execute the low priority task as non-cacheable, thereby reducing impact to other threads. This solution has drawbacks, however. For example, performance of non-cacheable tasks can be significantly degraded.

Another solution is way-locking, which locks a portion of code or data in the cache once the code or data reaches the cache, thereby preventing thrashing. However, way-locking limits the cache usage, especially for multi-threaded or multi-core shared caches.

Aspects of the present disclosure are related to constraining or limiting way allocation for set associative cache systems. More specifically, aspects of the present disclosure enable selective way identifiers (IDs) limiting which ways are not available for use by specific applications/tasks/data. The term “data” is used generally, and refers to tasks, threads, program codes, execution environments, etc.

A programmable mechanism may be provided to assign different ways to different applications/tasks/data. That is, applications/tasks/data may be limited to specific ways. A user defines an address range that is applicable for data or code that is allocated to a subset of ways in the cache. The address range may be a virtual address range or a physical address range. For example, the address range may correspond to a memory address of a lower level cache, an off-chip system memory, etc. Allocating different ways to different memory address ranges reduces the impact on the performance and thrashing of other code or data execution using a shared cache. The user allocation may be static or dynamic. The data or code may include a data segment of a processing thread, a data segment of a specific application, a data segment of specific program code, a data segment of a specific execution environment, and/or a data segment of an operating system.

In an example with an eight-way associative cache, a specific task executed in a software thread may be limited to one or two ways of the cache, enabling the task to enjoy benefits from cache prefetching and miss rate reduction, while reducing impact to other software threads.

The way limitations of the present disclosure may have applications in security. For example, access of different threads or execution environments may be limited to specific mutually exclusive ways. One security domain execution thread may be cached in a different way than another security domain execution thread, preventing threads of certain security domains from accessing data of the other security domain threads by isolating the data and/or the code. Thus, the cache may be divided into two or more classes where one security domain stores data and/or code in the first class (e.g., first set of ways) and the second security domain stores data in the second class (e.g., second set of ways).

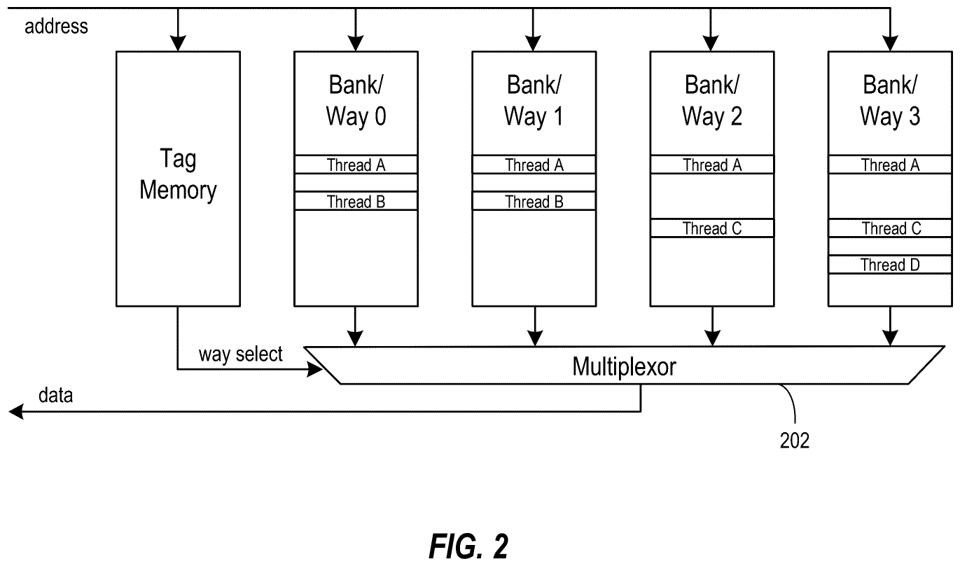

FIG. 2 is a block diagram illustrating limits on ways in a four-way associative cache, in accordance with various aspects of the present disclosure. In the example of FIG. 2, a cache includes four ways (way 0, way 1, way 2, and way 3.) Although FIG. 2 illustrates each way in a separate cache bank, the present disclosure is not so limited, as more than one way may reside within a single bank. A tag memory (TAG Mem) is also shown in FIG. 2 to provide way indices in response to addresses received from a processor, such as the CPU 102, GPU 104, DSP, 106, or NPU 108 of FIG. 1. A multiplexor 202 receives a way select signal (way sel) from the tag memory to enable access to data in the way, corresponding to the address received from the processor.

In existing systems, each memory address may be allocated to any of the four ways. According to aspects of the present disclosure, a limited allocation scheme limits specific tasks executed in software threads to one, two, three, or four ways of the cache. Although one, two, three (not a power of two) and four are listed as examples, the limits can be set to other amounts, as well. In the example of FIG. 2, four threads (Thread A, Thread B, Thread C, and Thread D) run in parallel in a multi-core system or a multi-threaded single core. Thread A utilizes all four ways. Thread B utilizes only two ways: way 0 and way 1. Thread C utilizes only two ways: way 2 and way 3. Thread D utilizes a single way (e.g., way 3), similar to a direct mapped system. Thread D may be a low priority thread in terms of performance. Although Thread D is limited to a single way, Thread D still benefits from cache prefetching and miss rate reduction, while minimizing impact to other software threads.

As shown in the example of FIG. 2, when Thread B is active, Thread B has a reduced impact on Thread A in terms of cache content thrashing. Similarly, Thread C has a reduced impact on Thread A. The less critical Thread D effectively receives a direct mapped cache with one-fourth of the total cache size to be used for Thread D's purposes. Thread D's performance will be affected, but Thread D still enjoys the caching facilities of locality in time and space, as well as the benefits of prefetching. In the example of FIG. 2, Threads B or C are of mid importance, and receive a two way allocation, effectively mapped to a cache with half of the total size and two way associativity. The two way allocation can be the same (not shown), or different as illustrated in the example of FIG. 2.

A use case example will now be described with respect to a mobile device with multiple technologies utilizing shared resources. In this example use case, three applications include fifth generation new radio (5G NR), long term evolution (LTE), and cellular vehicle-to-everything (CV2X) communications. The NR application timeline is very stringent, especially for frequency range two (FR2) cases. Thus, the NR application should have the best cache behavior. LTE is less critical but also important in terms of timeline, as call drops can occur. CV2X may or may not be important depending on the information carried. If the information is non-safety related and informative only, the CV2X application can be relieved from a latency perspective to a certain extent, but still utilize the same hardware and cache for code or data.

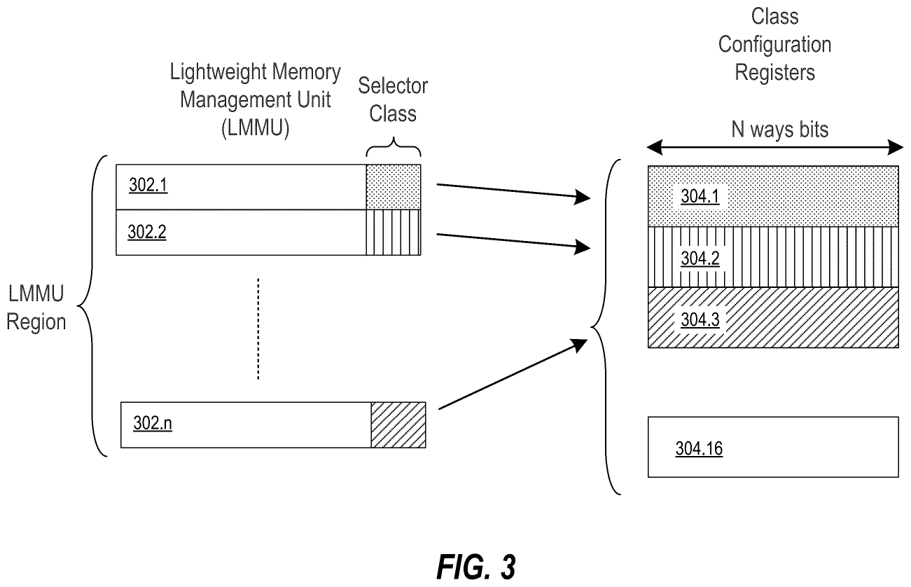

Multiple implementations are possible for the selected way ID. An example microarchitecture is now described as one possible implementation with respect to FIG. 3. FIG. 3 is a block diagram illustrating a microarchitecture for implementing limited way assignments, in accordance with various aspects of the present disclosure. As noted, the selected way ID may control a number of way IDs a section of virtual address space can use. A lightweight memory management unit (LMMU) may have multiple LMMU regions 302 (302.1, 302.2, . . . 302.n). Each LMMU region may have three bits to select a behavior class (also referred to as a sector class or more simply ‘class’). In the example of FIG. 3, those classes are divided into four data classes and four code classes.

Each class has a configuration register 304 (304.1, 304.2, 304.3, . . . 304.16): four registers (304.1-304.4) for an instruction cache, four registers (304.5-304.8) for a data cache, and eight registers (304.9-304.16) for a unified cache. Each class indicates a number of ways bits. That is, each class defines which cache ways are accessible by related content.

In the example of FIG. 3, new allocations from a class are placed in an unblocked way. In one implementation, the polarity of bits is as follows: bit value=0 indicates data/code may be placed in this way, or bit value=1 indicates data/code is blocked and may not be placed in this way.

When a cache line is fetched into a cache, the cache line may only be allocated in an unblocked way. Based on the virtual address, a relevant LMMU region 302 is found. From the LMMU region 302, the class is detected and from the class, the blocked ways list is taken from the corresponding class configuration register 304. In the example of FIG. 3, the class of the first LMMU region 302.1 corresponds to the first class configuration register 304.1. The class of the second LMMU region 302.2 corresponds to the second class configuration register 304.2. The class of the nth LMMU region 302.n corresponds to the third class configuration register 304.3. The blocked ways are passed to a replacement unit when requesting a way. The replacement unit is responsible for replacing content of a cache line with new data/code arriving (e.g., thrashing of previous information and placing newly arrived information to become part of the cache content)

Cache locking is now described with respect to constraints for way limiter programming and way allocation by the replacement unit. When a line lock is attempted in response to a software command, hardware ensures the way is not the last available way for the cache index. The virtual address to be locked is looked for in the LMMU. From the LMMU region 302, the sector class is taken and from the class, the list of allowed ways is taken from the corresponding class configuration register 304.

The list of allowed ways is compared to a current lock status of the cache index. If all other allowed ways in that index are already locked, the lock command is refused with the interrupt and the cache line is allocated without lock.

Software configures the classes such that a specific way may not be locked by more than one class. The LMMU and classes default to allowing code to access any address as cacheable without lock options.

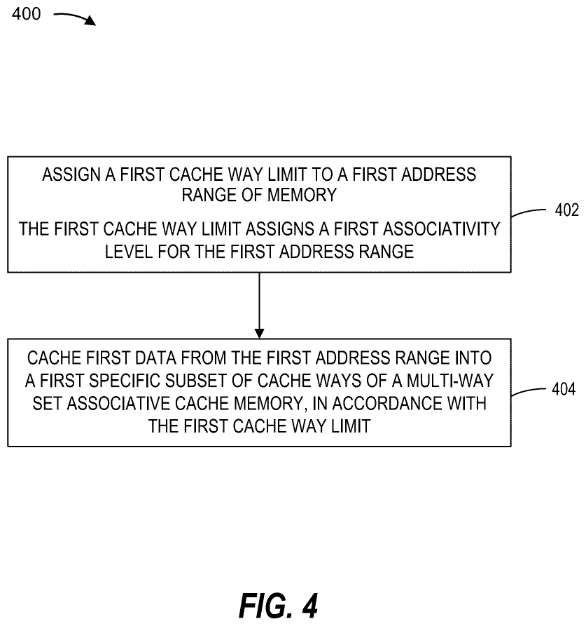

FIG. 4 is a flow diagram illustrating an example process 400 performed, for example, by a mobile device, in accordance with various aspects of the present disclosure. The example process 400 is an example of data caching with way limits.

As shown in FIG. 4, in some aspects, the process 400 may include assigning a first cache way limit to a first address range of memory. The first cache way limit assigns a first associativity level for the first address range (block 402). The first address range may correspond to a data segment of a processing thread, a data segment of a specific application, a data segment of specific program code, a data segment of a specific execution environment, and/or a data segment of an operating system. In some implementations, the assigning may occur dynamically. The first cache way limit corresponds to a first security domain and is mutually exclusive to a second cache way limit corresponding to a second security domain.

In some aspects, the process 400 may include caching first data from the first address range into a first specific subset of cache ways of a multi-way set associative cache memory, in accordance with the first cache way limit (block 404).

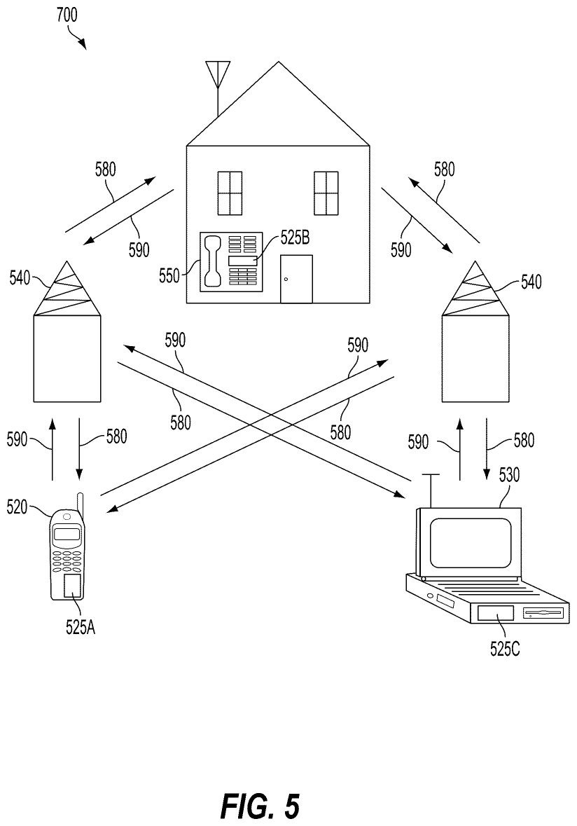

FIG. 5 is a block diagram showing an exemplary wireless communications system 500, in which an aspect of the present disclosure may be advantageously employed. For purposes of illustration, FIG. 5 shows three remote units 520, 530, and 550, and two base stations 540. It will be recognized that wireless communications systems may have many more remote units and base stations. Remote units 520, 530, and 550 include integrated circuit (IC) devices 525A, 525B, and 525C that include the disclosed set associative cache memory system with limited way allocation. It will be recognized that other devices may also include the disclosed set associative cache memory system with limited way allocation, such as the base stations, switching devices, and network equipment. FIG. 5 shows forward link signals 580 from the base stations 540 to the remote units 520, 530, and 550, and reverse link signals 590 from the remote units 520, 530, and 550 to the base stations 540.

In FIG. 5, remote unit 520 is shown as a mobile telephone, remote unit 530 is shown as a portable computer, and remote unit 550 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 5 illustrates remote units according to the aspects of the present disclosure, the disclosure is not limited to these exemplary illustrated units. Aspects of the present disclosure may be suitably employed in many devices, which include the disclosed set associative cache memory system with limited way allocation.

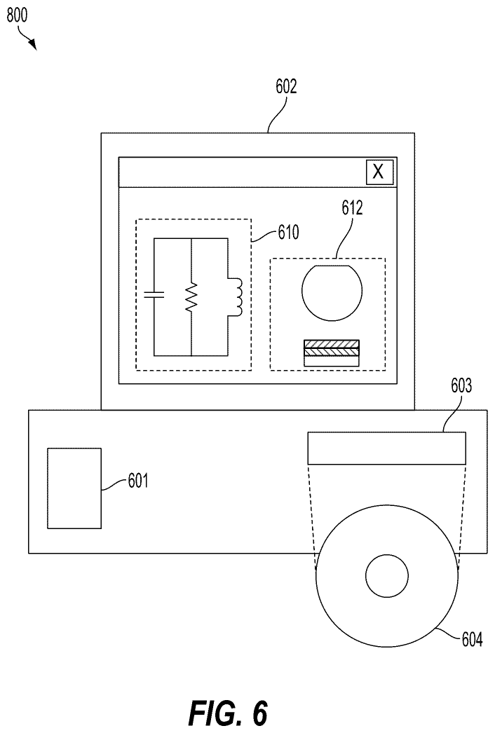

FIG. 6 is a block diagram illustrating a design workstation 600 used for circuit, layout, and logic design of a semiconductor component, such as the set associative cache memory system with limited way allocation disclosed above. The design workstation 600 includes a hard disk 601 containing operating system software, support files, and design software such as Cadence or OrCAD. The design workstation 600 also includes a display 602 to facilitate design of a circuit 610 or a semiconductor component 612, such as the set associative cache memory system with limited way allocation. A storage medium 604 is provided for tangibly storing the design of the circuit 610 or the semiconductor component 612 (e.g., the PLD). The design of the circuit 610 or the semiconductor component 612 may be stored on the storage medium 604 in a file format such as GDSII or GERBER. The storage medium 604 may be a CD-ROM, DVD, hard disk, flash memory, or other appropriate device. Furthermore, the design workstation 600 includes a drive apparatus 603 for accepting input from or writing output to the storage medium 604.

Data recorded on the storage medium 604 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 604 facilitates the design of the circuit 610 or the semiconductor component 612 by decreasing the number of processes for designing semiconductor wafers.

### Example Aspects

Aspect 1: A method of data caching, comprising: assigning a first cache way limit to a first address range of memory, the first cache way limit assigning a first associativity level for the first address range; and caching first data from the first address range into a first specific subset of cache ways of a multi-way set associative cache memory, in accordance with the first cache way limit.
Aspect 2: The method of Aspect 1 or 2, in which the first address range corresponds to a data segment of a processing thread.
Aspect 3: The method of any of the preceding Aspects, in which the first address range corresponds to a data segment of a specific application.
Aspect 4: The method of any of the preceding Aspects, in which the first address range corresponds to a data segment of specific program code.
Aspect 5: The method of any of the preceding Aspects, in which the first address range corresponds to a data segment of a specific execution environment.
Aspect 6: The method of any of the preceding Aspects, in which the first address range corresponds to a data segment of an operating system.
Aspect 7: The method of any of the preceding Aspects, in which the first cache way limit indicates at least one cache way.
Aspect 8: The method of any of the preceding Aspects, in which the assigning occurs dynamically.
Aspect 9: The method of any of the preceding Aspects, further comprising: assigning a second cache way limit to a second address range of the memory, the second cache way limit assigning a second associativity level for the second address range; and caching second data from the second address range into a second specific subset of cache ways of the multi-way set associative cache memory, the second specific subset being mutually exclusive from the first specific subset.

Aspect 10: The method of any of the preceding Aspects, in which the first cache way limit corresponds to a first security domain and is mutually exclusive to a second cache way limit corresponding to a second security domain.

Aspect 11: An apparatus for data caching, comprising: at least one memory; and at least one processor coupled to the at least one memory, the at least one processor configured: to assign a first cache way limit to a first address range of memory, the first cache way limit assigning a first associativity level for the first address range; and to cache first data from the first address range into a first specific subset of cache ways of a multi-way set associative cache memory, in accordance with the first cache way limit.

Aspect 12: The apparatus of Aspect 11, in which the first address range corresponds to a data segment of a processing thread.

Aspect 13: The apparatus of any of the Aspects 11-12, in which the first address range corresponds to a data segment of a specific application.

Aspect 14: The apparatus of any of the Aspects 11-13, in which the first address range corresponds to a data segment of specific program code.

Aspect 15: The apparatus of any of the Aspects 11-14, in which the first address range corresponds to a data segment of a specific execution environment.

Aspect 16: The apparatus of any of the Aspects 11-15, in which the first address range corresponds to a data segment of an operating system.

Aspect 17: The apparatus of any of the Aspects 11-16, in which the first cache way limit indicates at least one cache way.

Aspect 18: The apparatus of any of the Aspects 11-17, in which the at least one processor is further configured to assign dynamically.

Aspect 19: The apparatus of any of the Aspects 11-18, in which the at least one processor is further configured: to assign a second cache way limit to a second address range of the memory, the second cache way limit assigning a second associativity level for the second address range; and to cache second data from the second address range into a second specific subset of cache ways of the multi-way set associative cache memory, the second specific subset being mutually exclusive from the first specific subset.

Aspect 20: The apparatus of any of the Aspects 11-19, in which the first cache way limit corresponds to a first security domain and is mutually exclusive to a second cache way limit corresponding to a second security domain.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device.

Moreover, the scope of the present disclosure is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the present disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in RAM, flash memory, ROM, erasable programmable read-only memory (EPROM), EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the present disclosure is provided to enable any person skilled in the art to make or use the present disclosure. Various modifications to the disclosure will be readily apparent to those skilled in the art, and the generic principles defined may be applied to other variations without departing from the spirit or scope of the disclosure. Thus, the present disclosure is not intended to be limited to the examples and designs described, but is to be accorded the widest scope consistent with the principles and novel features disclosed.

1. A method of data caching, comprising:
assigning a first cache way limit to a first address range of memory, the first cache way limit assigning a first associativity level for the first address range, the first cache way limit indicating cache way identities of a first specific subset of cache ways available for first data based on an address corresponding to the first data being within the first address range;
determining that the address corresponding to the first data is within the first address range; and
caching the first data from the first address range into the first specific subset of cache ways of a multi-way set associative cache memory, in accordance with the first cache way limit, the caching comprising selectively permitting cache way identity usage for the first data in the first specific subset of cache ways based on the determining.

2. The method of claim 1, in which the first address range corresponds to a data segment of a processing thread.

3. The method of claim 1, in which the first address range corresponds to a data segment of a specific application.

4. The method of claim 1, in which the first address range corresponds to a data segment of specific program code.

5. The method of claim 1, in which the first address range corresponds to a data segment of a specific execution environment.

6. The method of claim 1, in which the first address range corresponds to a data segment of an operating system.

7. The method of claim 1, in which the first cache way limit indicates at least one cache way.

8. The method of claim 1, in which the assigning occurs dynamically.

9. The method of claim 1, further comprising:
assigning a second cache way limit to a second address range of the memory, the second cache way limit assigning a second associativity level for the second address range; and
caching second data from the second address range into a second specific subset of cache ways of the multi-way set associative cache memory, the second specific subset being mutually exclusive from the first specific subset.

10. The method of claim 1, in which the first cache way limit corresponds to a first security domain and is mutually exclusive to a second cache way limit corresponding to a second security domain.

11. An apparatus for data caching, comprising:
at least one memory; and
at least one processor coupled to the at least one memory, the at least one processor configured:
to assign a first cache way limit to a first address range of the at least one memory, the first cache way limit assigning a first associativity level for the first address range, the first cache way limit indicating cache way identities of a first specific subset of cache ways available for first data based on an address corresponding to the first data being within the first address range;
to determine that the address corresponding to the first data is within the first address range; and
to cache the first data from the first address range into the first specific subset of cache ways of a multi-way set associative cache memory, in accordance with the first cache way limit, the caching comprising selectively permitting cache way identity usage for the first data in the first specific subset of cache ways based on the determining.

12. The apparatus of claim 11, in which the first address range corresponds to a data segment of a processing thread.

13. The apparatus of claim 11, in which the first address range corresponds to a data segment of a specific application.

14. The apparatus of claim 11, in which the first address range corresponds to a data segment of specific program code.

15. The apparatus of claim 11, in which the first address range corresponds to a data segment of a specific execution environment.

16. The apparatus of claim 11, in which the first address range corresponds to a data segment of an operating system.

17. The apparatus of claim 11, in which the first cache way limit indicates at least one cache way.

18. The apparatus of claim 11, in which the at least one processor is further configured to assign dynamically.

19. The apparatus of claim 11, in which the at least one processor is further configured:
to assign a second cache way limit to a second address range of the at least one memory, the second cache way limit assigning a second associativity level for the second address range; and
to cache second data from the second address range into a second specific subset of cache ways of the multi-way set associative cache memory, the second specific subset being mutually exclusive from the first specific subset.

20. The apparatus of claim 11, in which the first cache way limit corresponds to a first security domain and is mutually exclusive to a second cache way limit corresponding to a second security domain.
